(19) United States
(12) Patent Application Publication
(10) Pub. No.: US 2009/0024832 A1
(43) Pub. Date: Jan. 22, 2009

(54) PROCESS FOR THE AUTOMATIC PRODUCTION OF A PROCESSOR FROM A MACHINE DESCRIPTION

(76) Inventor: Gordon Cichon, Munich (DE)

Correspondence Address: 24IP LAW GROUP USA, PLLC, 12 E. LAKE DRIVE, ANNAPOLIS, MD, 21403, US

(21) Appl. No.: 10/595,965

(22) PCT Filed: Nov. 23, 2004
(86) PCT No.: PCT/DE04/02580

§ 371 Date: Jul. 6, 2006

(30) Foreign Application Priority Data
Nov. 24, 2003 (DE) 103 55 112.3
Jan. 28, 2004 (DE) 10 2004 004 434.1

(51) Int. Cl. G06F 9/308

(52) U.S. Cl. 712/22; 712/E09.019

(57) ABSTRACT

The invention is based on the task to undertake machine descriptions, with which an automated optimal hardware design of SIMD processors can be carried out. This is solved by the fact that functional units are selected from a criterion in the machine description, which is vector processible. A first or second reduced functional unit are selectively defined from a respective vector-processing functional unit, in which the reduced functional units process only a data element of a vectoral value. All reduced functional units, which use common control signals for the processing of a respective data element belonging to the vectoral value, are condensed to a disk. Reduced functional units, which process the same data elements in a sequence at least indirectly, are condensed to a disk module. The disk is reproduced with the contained reduced functional units so often that all reduced functional units represent the functionality of their respective selected vector-processing functional unit.

### BACKGROUND OF THE INVENTION

1. Field of the Invention

The invention concerns a process for the production of an SIMD processor, which contains common control signal sharing disks for the processing of different data respectively, in which the geometry of the processor is produced at least indirectly from a machine description, which consists of a database, contains definitions of several functional units, consist of at least the parameters of the number and types of the inputs and outputs and the connection of the functional units with other functional units.

2. Brief Description of the Related Art

The state-of-the-art technology shows clearly that digital signal processor (DSP) will gain in importance in future. Their main application areas are systems, in which signal-processing tasks such as implementation of filters and calculation of spectra, have to be taken over. They replace the analogue or digital switches tailored specifically for each application.

The advantage of the digital signal processors (DSP) against such application-specific systems lies in its universal usability. This is due to the fact that its programmability is free and because of that adaptability to special tasks within an application area is made possible.

Besides, it also proves to be that the digital signal processors are laid out preferably as SIMD (Single Instruction Multiple Data)-processors.

This advantage is also reflected in a higher reusability of hardware and software and results in low development costs as well as shorter transition times in the marketability.

But, particularly for the latter advantages, it requires that, for the development of an SIMD-processor, automatic processes must substantiate the marketability efficiently. According to the state-of-the-art technology, design and test environments are provided for the design of such DSP processor-description languages.

Known processor description languages are all strongly compiler-oriented. That is, starting from a given hardware, special optimisations and adaptations of the used software to the hardware of a DSP are undertaken most extensively by hand by the development engineer, often using assembler programming.

Since assembler programming is very demanding, time consuming and error-prone in practice, often a compromise path is selected for the software development. Moreover, the programs are developed in a standard language and critical program locations are optimised later after the translation by means of classical compiler on assembler level. The advantage of this method is the simplification and speeding up of the development process. The disadvantage is, not only the generation of new error source, but also the danger that, under certain circumstances, a fresh optimisation of the critical program locations must be carried out after each alteration of a program in the standard language.

Using of another method to undertake the optimisation of SIMD-processors through optimised automated hardware design, which is supported by machine descriptions, and concern the register transfer level or netlist, is not known for the state-of-the art technology.

Consequently, the inventive nature of the task is to undertake a machine description starting from a given processor description, with which an automated optimal hardware design of SIMD processors can be carried out.

### SUMMARY OF THE INVENTION

According to the invention, the nature of the task is solved by the fact that an altered machine description is produced and used as the basis for the production of the geometry of such SIMD processor, that functional units are selected from a criterion in the machine description, which is vector-processible. Further, a first or second reduced functional unit is selected defined from a respective vector-processing functional unit, in which the reduced functional units process only a data element of a vectoral value as component of the respective vector-processing functional unit.

All reduced functional units, which use common control signals for the processing of a data element belonging to the vectoral value respectively, are condensed to a disk. Reduced functional units, which process the same data elements in a sequence at least indirectly, are condensed to a disk module. The respective disk is arranged repeatedly in such a way that the disk with the contained reduced functional units is reproduced so often that all reduced functional units represent the functionality of their respectively selected vector-processing functional unit.

This solution aims to keep very low a loss of information to the functional units to be formed newly for an especially favourable formability for a synthesis. An optimised representation of the original processor description is achieved with this changed machine description, which receives an especially favourable form for a transformation process for the generation of the geometry of the SIMD processor.

An additional variant of the inventive solution is achieved by the fact that the criterion in the machine description represents the type of the inputs and/or outputs or the functionalities, as long as this is defined in the machine description.

It is achieved with a further variant of the inventive solution that disks are combined to a respective disk module. The respective disk module is identified by the fact that the machine description contains information as to which of its functional units process vectoral values. Moreover, the respective vector-processing functional unit is divided on the respective vectoral value to be processed.

An additional variant of the inventive solution is formed in such a way that disks are combined to a respective disk module. Further, the respective disk module is identified by the fact that the machine description contains information as to which functional units can be divided into disks.

A formation of the additional variants of the inventive solution is achieved by the fact that disks are combined to a respective disk module. Further, the respective disk module is identified by the fact that the machine description contains information as to which of the functional units processing vectoral values can be divided into disks.

A further formation of the additional variants of the inventive solution is achieved by the fact that disks are combined to a respective disk module and that besides the respective disk module is identified by the fact that the machine description contains information as to which functional units process vectoral values and cannot be divided into disks. These functional units are divided on the respective vectoral value to be processed, except the functional units, which are marked as functional units that cannot be divided into disks.

An execution of the inventive solution provides that a respective interconnecting network between functional units of the processor is produced by the fact that a respective disk module is present as identified and a respective signal is implemented in the machine description by the fact that it is represented within the respective disk module via connections of a respectively unambiguously nameable internal connection in the respective disk module.

A variant of the execution of the inventive solution provides that a disk-wide interconnecting network is formed through a connection of a respective input connection of a first reduced functional unit with a first and/or second output connection of a first and/or a second reduced functional unit, in which the first reduced functional unit lies within a disk of the disk module and the second functional unit outside a disk of the disk module.

A further variant of the execution of the inventive solution provides that respective connections of a first and/or a second disk are combined into a respective combining interconnecting network of individual signals (Signal belongs to signals related to each other with several data elements).

A special variant of the execution of the inventive solution provides that vector-value signals are divided on a first and a second disk as individual connection from a combined interconnecting network present respectively in an isolating interconnecting network.

An additional formation of the inventive solution is undertaken by the fact that a hierarchy-level interconnecting network is formed by a connection of a respective input connection of the first reduced functional unit with a first and/or second output connection of the first and/or a second reduced functional unit, in which the respective hierarchy-level interconnecting network produces connections only in the respective hierarchy level.

It is implemented in a special embodiment of the additional formation of the inventive solution that a disk-internal interconnecting network is formed through a connection of a respective input connection of a first reduced functional unit to a respective output connection of a second reduced functional unit of the first disk

In this case, the first and second reduced functional unit lies within the disk module and within the respective disk. Moreover, an additional signal of a connection of the disk is realised by the fact that a connection to the disk-internal interconnecting network is made from the connection to the interface of the disk, in which this is represented as connection from and to connections nameable unambiguously in the respective disk module.

In a further variant of the additional formation of the inventive solution, it is implemented that the respective connections of individual vector-value signals of several data elements of the next higher hierarchy level of a first and a second disk are combined into a combining interconnecting network.

Still other aspects, features, and advantages of the present invention are readily apparent from the following detailed description, simply by illustrating a preferable embodiments and implementations. The present invention is also capable of other and different embodiments and its several details can be modified in various obvious respects, all without departing from the spirit and scope of the present invention. Accordingly, the drawings and descriptions are to be regarded as illustrative in nature, and not as restrictive. Additional objects and advantages of the invention will be set forth in part in the description which follows and in part will be obvious from the description, or may be learned by practice of the invention.

### BRIEF DESCRIPTION OF THE DRAWINGS

For a more complete understanding of the present invention and the advantages thereof, reference is now made to the following description and the accompanying drawings, in which:

FIG. 1 is a block diagram of a preferred embodiment of the present invention.

### DETAILED DESCRIPTION OF THE PREFERRED EMBODIMENTS

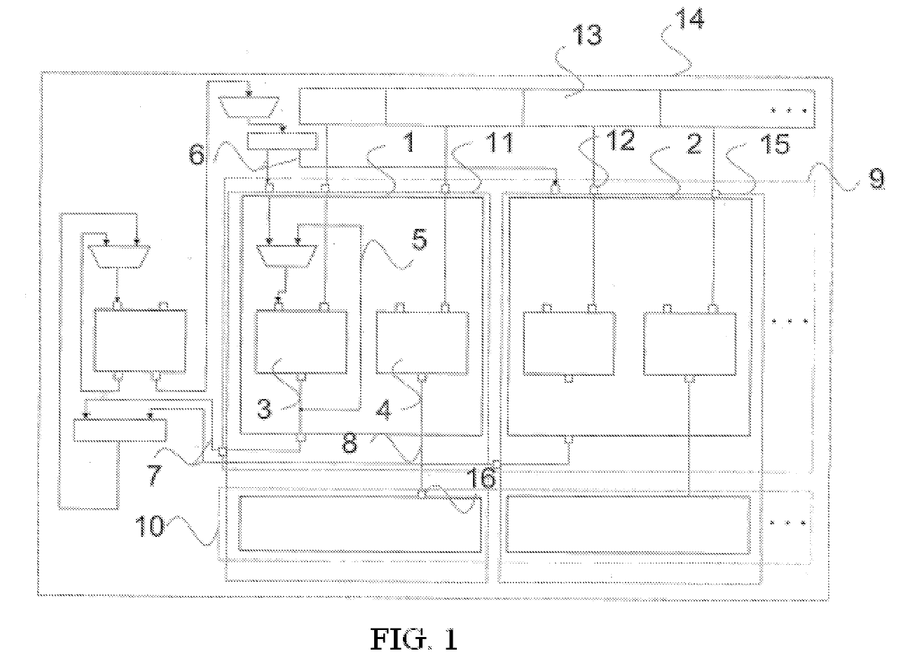

A preferred embodiment of the present invention is described below with reference to FIG. 1. A block diagram of the geometry of the SIMD processor 14 produced through a changed machine description according to the invention is represented in the correlated diagram.

It can be seen therein that the respectively correlated data elements of the vectoral value 13 to be processed in the SIMD processor 14 are led to the first or second reduced functional unit 3; 4.

The first or second reduced functional unit 3; 4 have been selected corresponding to the criterion from the vector-processing functional units of the original machine description in such a way that they process only a data element of a vectoral value 13 as component of the respective vector-processing functional unit 9.

The criteria used for the selection represent the type of the inputs and/or outputs or the functionalities in the machine description as long as it is defined in this.

All reduced functional units, which use the common control signals for the processing of a data element belonging to the vectoral value 13 respectively, are combined in a disk. Besides, reduced functional units, which process the same data elements in a sequence at least indirectly, are associated with a disk module 11.

The respective disk is arranged in the SIMD processor 14 repeatedly in such a way that the disk with the contained reduced functional units is reproduced so often that all reduced functional units represent the functionality of their respectively selected vector-processing functional unit 9.

A interconnecting network between the functional units of the SIMD processor 14 is formed by the fact that on one hand a respective disk module 11 is presently identified and on the other hand a respective signal of the machine description in the SIMD processor 14 is realised by the fact that it is represented within the disk module 11 via connections of a respectively unambiguously nameable internal connection 16 in the respective disk module 11.

A disk-wide interconnecting network 8 is formed through a connection of a respective input connection of a first reduced functional unit 3 with a first and/or second output connection of a first and/or a second/further reduced functional unit 3; 4. Moreover, the first reduced functional unit 3 lies within a disk of the disk module 11 and the second reduced functional unit 4 outside a disk of the disk module 11.

The respective connections of a first and/or a second disk 1, 2 are combined in a respectively combined interconnecting network 7 of individual vector-value signals, i.e. the respective signal belongs to signals of several data elements related to each other.

Further it can be seen in the drawing that vector-value signals are divided on a first and a second disk 1; 2 as individual connection from a combined interconnecting network 7 present respectively in an isolating interconnecting network 6.

A disk-internal interconnecting network 5 is formed through a connection of a respective input connection of a first reduced functional unit 3 to a respective output connection of a second reduced functional unit 4 of the first disk 1. Moreover, the first and second reduced functional unit 3; 4 lie within the disk module 11 and within the respective disk.

Moreover, in this case an additional signal of a connection of the disk is realised by the fact that a connection to the disk-internal interconnecting network 5 is made from the connection to the interface of the disk. Besides, this connection is represented as connection from and to connections nameable respectively unambiguously in the respective disk module 11.

As further shown in FIG. 1, the system includes a disk-wide interconnecting network 8, a further vector-processing functional unit 10, a disk module connection 12, a further disk module 15, and hierarchy levels interconnecting network 17.

The foregoing description of the preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiment was chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

What is claimed is:

1. A process for the production of an SIMD processor, which contains common control signal sharing disks for the processing of different data respectively, in which the geometry of the processor is produced at least indirectly from a machine description, which consists of a database, contains definitions of several functional units, consist of at least parameters of the number and types of the inputs and outputs and the connection of the functional units with other functional units, comprising the steps of:
producing an altered machine description and using said altered machine description as the basis for the production of a geometry of the SIMD processor in such a way that functional units are selected from a criterion in the machine description, which are vector-processible, that a first or second reduced functional unit are selected defined from a respective vector-processing functional unit, in which the reduced functional units process only a data element of a vectoral value as component of the respective vector-processing functional unit, that all reduced functional units, which use common control signals for the processing of a data element belonging to the vectoral value respectively, are condensed to a disk, that reduced functional units, which process the same data elements in a sequence at least indirectly, are condensed to a disk module, that the respective disk is arranged repeatedly in such a way that the disk with the contained reduced functional units is reproduced so often that all reduced functional units represent the functionality of their respectively selected vector-processing functional unit.

2. A process according to claim 1 wherein a criterion in the machine description represents the type of the inputs and/or outputs or the functionalities, as long as these are defined in the machine description.

3. A process according to claim 1 wherein disks are combined to a respective disk module, the respective disk module is identified by the fact that the machine description contains information as to which of its functionalities process vectoral values and that the respective vector-processing functional unit is divided on the vectoral value to be processed respectively.

4. A process according to claim 2 wherein disks are combined to a respective disk module, the respective disk module is identified by the fact that the machine description contains information as to which of its functionalities process vectoral values and that the respective vector-processing functional unit is divided on the vectoral value to be processed respectively.

5. A process according to claim 1 wherein the discs are combined to a respective disk module, that the respective disk module is identified by the fact that the machine description contains information as to which functional units can be divided into disks.

6. Process according to claim 2 wherein the discs are combined to a respective disk module, that the respective disk module is identified by the fact that the machine description contains information as to which functional units can be divided into disks.

7. A process according to claims 1 wherein the discs are combined to a respective disk module, the respective disk module is identified by the fact that the machine description contains information as to which of the functional units process vectoral values, that the machine description contains information as to which functional units cannot be divided into disks and that these functional units are divided on the vectoral value to be processed respectively, except the functional units, which are indicated as functionalities that cannot be divided into disks.

8. A process according to claims 2 wherein the discs are combined to a respective disk module, the respective disk module is identified by the fact that the machine description contains information as to which of the functional units process vectoral values, that the machine description contains information as to which functional units cannot be divided into disks and that these functional units are divided on the vectoral value to be processed respectively, except the functional units, which are indicated as functionalities that cannot be divided into disks.

9. A process according to claim 3 wherein a respective interconnecting network is produced between vector-processing functional units of the SIMD processor by the fact that a respective disk module is present identified, that a respective signal is realised in the machine description by the fact that it is represented within the disk module via connections of a respectively unambiguously nameable internal connection in the respective disk module.

9. A process according to claim 8 wherein a respective interconnecting network is produced between vector-processing functional units of the SIMD processor by the fact that a respective disk module is present identified, that a respective signal is realised in the machine description by the fact that it is represented within the disk module via connections of a respectively unambiguously nameable internal connection in the respective disk module.

10. A process according to claim 9 wherein a disk-wide interconnecting network is formed through a connection of a respective input connection of a first reduced functional unit with a first and/or second output connection of a first and/or a second reduced functional unit in which the first reduced functional unit lies within a disk of the disk module and the second functional unit outside a disk of the disk module.

11. A process according to the claim 9 wherein the respective connections of a first and/or a second disk is combined into a respective combining interconnecting network of individual vector-value signals.

11. A process according to the claim 10 wherein the respective connections of a first and/or a second disk is combined into a respective combining interconnecting network of individual vector-value signals.

12. A process according to claim 12 wherein vector-value signals are divided on a first and a second disk as individual connection from a combined interconnecting network present respectively in an isolating interconnecting network.

13. A process according to claim 9 wherein a hierarchy-level interconnecting network is formed through a connection of a respective input connection of the first reduced functional unit with a first and/or second output connection of the first and/or a second reduced functional unit in which the respective hierarchy-level interconnecting network produces connections only in the respective hierarchy level.

14. A process according to claim 10 wherein a hierarchy-level interconnecting network is formed through a connection of a respective input connection of the first reduced functional unit with a first and/or second output connection of the first and/or a second reduced functional unit in which the respective hierarchy-level interconnecting network produces connections only in the respective hierarchy level.

15. A process according to claim 11 wherein a disk-internal interconnecting network is formed through a connection of a respective input connection of a first reduced functional unit to a respective output connection of a second reduced functional unit of the first disk in which the first and second reduced functional unit lie within the disk module and within the respective disk, that an additional signal of a connection of the disk is realised by the fact that a connection to the disk-internal interconnecting network is made from the connection to the interface of the disk, in which this is represented as connection from and to connections nameable respectively unambiguously in the respective disk module.

16. A process according to claim 15 wherein the respective connections of individual vector-value signals of several data elements of the next higher hierarchy level of a first and a second disk are combined into a combining interconnecting network.
